(19) United States
(12) Patent Application Publication
(10) Pub. No.: US 2007/0179685 A1
(43) Pub. Date: Aug. 2, 2007

(54) Trajectory generation using non-uniform rational B-splines

(76) Inventors: Mark Milam, La Habra, CA (US); Melvin Flores, Pasadena, CA (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/540,471

(22) Filed: Sep. 29, 2006

Related U.S. Application Data
(60) Provisional application No. 60/721,666, filed on Sep. 29, 2005.

(51) Int. Cl. G01C 23/00

(52) U.S. Cl. 701/3; 701/23

(57) ABSTRACT

A trajectory is generated using non-uniform rational B-splines. A feasible corridor is approximated with at least one convex polytope. The at least one convex polytope is defined by a plurality of vertices. The feasible corridor comprises a region in a trajectory space that satisfies a plurality of trajectory constraints for a vehicle to pass through the trajectory space. The vehicle comprises a plurality of vehicle constraints. A non-uniform rational B-spline (NURBS) definition is constructed that comprises: a plurality of NURBS basis functions, a plurality of control points that comprise the plurality of vertices, and a plurality of weight points. The plurality of vehicle constraints are parameterized with the plurality of NURBS basis functions. At least one trajectory is generated for the vehicle through the trajectory space where the at least on trajectory lies within the feasible corridor to satisfy the plurality of trajectory constraints.

### TECHNICAL FIELD

The invention relates generally to trajectory planning and, more particularly, to trajectory planning for unmanned and manned vehicles, such as spacecraft or aerial vehicles.

### BACKGROUND OF THE INVENTION

Various operations of spacecraft and other vehicles require precise trajectory planning or path planning to ensure that a vehicle proceeds to a desired destination in an optimum manner, while avoiding any obstacles. For example, an orbiting satellite may need to perform a rendezvous and proximity operation (RPO) whereby the satellite must follow a trajectory that places it in close proximity to another spacecraft for purposes of capture or maintenance of the satellite. Similarly, docking one spacecraft with another requires trajectory planning for one or both vehicles. Spacecraft re-entry and ascent guidance are other categories of trajectory planning applications. Yet another class of applications of trajectory planning is commercial aircraft routing and collision avoidance. A related class of applications is trajectory planning for autonomous unmanned aerial vehicles with terrain avoidance constraints.

In general, trajectory generation for dynamical systems consists in solving optimal control (OC) problems subject to dynamic constraints, boundary conditions, trajectory constraints, and actuator constraints. In obstacle avoidance problems, the bulk of the constraints are used to describe the obstacles, significantly increasing the amount of effort required to solve the OC problem and becoming a deterrent for the development of real-time algorithms.

For many decades now, researchers in robotics and computer science have dedicated significant effort into motion planning algorithms that concern obstacle avoidance. These efforts have concentrated in determining vehicle paths through free space at the expense of neglecting dynamic constraints or using a simplified version of them. In the area of control and dynamical systems, on the other hand, there has been significant effort to generate trajectories that take into account the dynamic and actuator constraints but typically neglect trajectory constraints or trivialize them. Thus, each of these approaches has its inherent limitations and there is still a need for a trajectory planning technique that does not suffer from the drawbacks of the prior art or that is able to leverage the results from both efforts. The present invention satisfies this need.

### SUMMARY OF THE INVENTION

The invention in one implementation encompasses a method. A feasible corridor is approximated with at least one convex polytope. The at least one convex polytope is defined by a plurality of vertices. The feasible corridor comprises a region in a trajectory space that satisfies a plurality of trajectory constraints for a vehicle to pass through the trajectory space. The vehicle comprises a plurality of vehicle constraints. A non-uniform rational B-spline (NURBS) definition is constructed that comprises: a plurality of NURBS basis functions, a plurality of control points that comprise the plurality of vertices, and a plurality of weight points. The plurality of vehicle constraints are parameterized with the plurality of NURBS basis functions. At least one trajectory is generated for the vehicle through the trajectory space where the at least on trajectory lies within the feasible corridor to satisfy the plurality of trajectory constraints.

Another implementation of the invention encompasses a method for generation of a trajectory for a vehicle through a trajectory space by solving an optimal control problem defined by at least one trajectory constraint for the trajectory space and at least one dynamic constraint for the vehicle. The optimal control problem comprises a differentially flat system. The optimal control problem is rewritten in terms of flat outputs of the differentially flat system to remove the at least one dynamic constraint. A feasible corridor is determined for the vehicle through the trajectory space. The feasible corridor is approximated through employment of a non-uniform rational B-spline (NURBS) parameterization to remove the at least one trajectory constraint. The optimal control problem is rewritten as a non-linear programming problem with weights of the NURBS parameterization as decision variables. The non-linear programming problem is solved to generate a local optimal trajectory within the feasible corridor.

Yet another implementation of the invention encompasses a method. An optimal control problem is rewritten in terms of flat outputs of the optimal control problem to obtain a modified control problem. A feasible corridor is defined with respect to at least one trajectory constraint through employment of a plurality of control points of the NURBS basis functions. The flat outputs of the modified control problem are parameterized by piecewise polynomial functions using non-uniform rational B-spline (NURBS) basis functions. The modified control problem is transcribed to a non-linear programming problem with weights of the NURBS basis functions as decision variables.

### BRIEF DESCRIPTION OF THE DRAWINGS

FIG. 1 is a representation of a diagram depicting the global determination of all possible feasible corridors in trajectory space, and the selection of an optimal corridor with respect to a desired objective.

FIG. 2 is a representation of a diagram depicting a NURBS parameterization to construct an inner approximation to the optimal corridor of FIG. 1.

FIG. 3 is a representation of a diagram depicting trajectory generation optimization within the optimal corridor constructed in FIG. 2, without the need to explicitly consider trajectory constraints.

FIG. 4 is a representation of a diagram depicting the generation of a local optimal trajectory that is also feasible with respect to dynamic and actuator constraints, by using NURBS weights as decision variables.

FIG. 5 is a representation of a trajectory space for a vehicle that satisfied trajectory constraints.

FIG. 6 is a representation of coordinate frames for a vertical takeoff and landing (VTOL) vehicle.

FIG. 7 is a representation of a feasible corridor for the VTOL vehicle through a trajectory space with respect to obstacles in the trajectory space.

FIG. 8 is a representation of a front view of a trajectory for the VTOL vehicle through the trajectory space.

FIG. 9 is an aerial view of the trajectory for the VTOL vehicle through the trajectory space.

FIG. 10 is a representation of Euler angles of the trajectory for the VTOL vehicle through the trajectory space.

FIG. 11 is a representation of body forces of the trajectory for the VTOL vehicle through the trajectory space.

### DETAILED DESCRIPTION OF THE INVENTION

Trajectory generation for dynamical systems consists of solving optimal control (OC) problems subject to dynamic constraints, boundary conditions, trajectory constraints and actuator constraints. In obstacle avoidance problems, the bulk of the constraints are used to describe the obstacles or rather free space, significantly increasing the amount of effort required to solve the OC problem and becoming a deterrent for the development of real-time algorithms.

For many decades now, researchers in robotics and computer science have dedicated significant effort into motion planning algorithms that concern obstacle avoidance. These efforts have concentrated in determining vehicle paths through free space at the expense of neglecting dynamic constraints or using a simplified version of them [8]. In the area of control and dynamical systems, on the other hand, there has been significant effort to generate trajectories that take into account the dynamic and actuator constraints but typically neglect trajectory constraints or trivialize them. Thus, each of these approaches has its inherent limitations and there is still a need for a trajectory planning technique that does not suffer from the drawbacks of the prior art or that is able to leverage the results from both efforts.

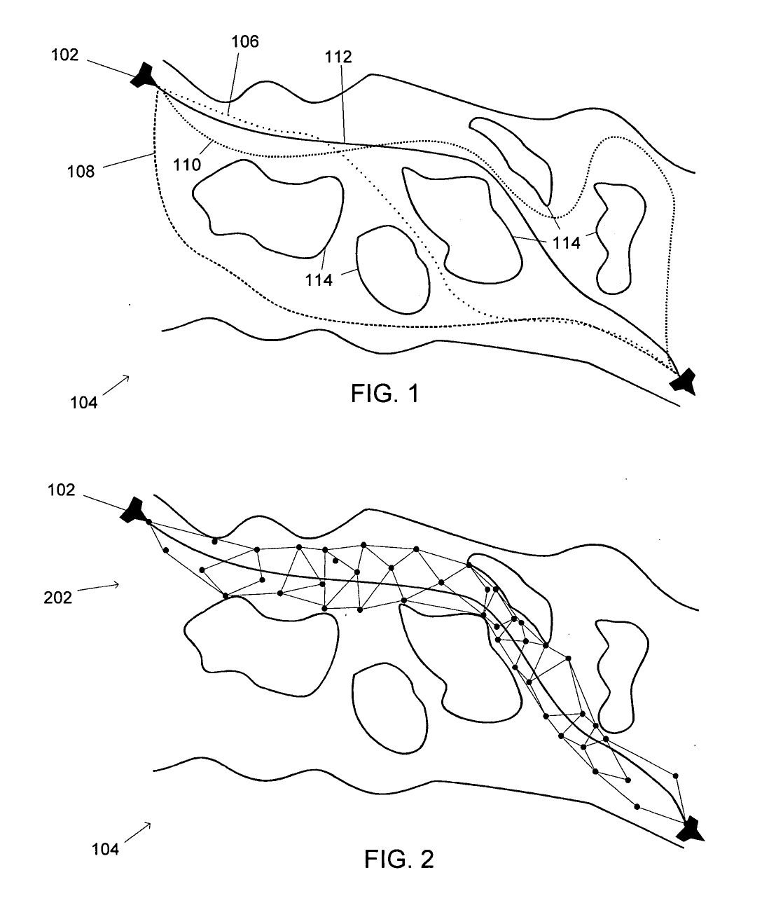

The present approach endeavors to bridge the gap between the above approaches and solve OC problems with full generality. The novelty of the approach resides in part in the ability to divide the trajectory generation procedure into two steps: a) construction of a feasible region with respect to trajectory constraints using convex polytopes and b) generation of local optimal trajectories mindful of such construction, which are guaranteed to remain inside the prescribed region and which are also feasible with respect to dynamic and actuator constraints. FIGS. 1-4 illustrate a procedure by which this approach could be applied to an unmanned aerial vehicle (UAV) for terrain avoidance or urban reconnaissance: a) a global solver is used to determine feasible corridors through trajectory space and to isolate an optimal corridor with respect to some objective, b) the corridor is inner approximated by the union of a set of convex polytopes whose vertices arise from a NURBS definition c) the inner approximation in b) allows for the removal of explicit trajectory constraints during trajectory generation, significantly reducing the effort required to solve the OC problem and d) a local optimal trajectory living in the feasible region with respect to trajectory constraints is generated which is also feasible with respect to dynamic and actuator constraints. The last step may fail to succeed due to various causes, among them, the infeasibility of the posed OC problem. In this event, apart from reviewing the OC problem itself, the above procedure may be reiterated starting from b) and inner approximate one of the other alternative routes leading to the final position.

Traditional numerical methods for generating locally optimal trajectories for dynamical systems may be classified into two general approaches: direct and indirect. Indirect methods are developed through the calculus of variations and arise in the form of first-order and second-order necessary and sufficient conditions of optimality [2][15][12][17]. Direct methods, on the other hand, rely on the direct transcription of the OC problem to a Nonlinear programming (NLP) problem via parameterization of the inputs and states, followed by a discretization of the resulting OC problem [1][17][9]. The reader is referred to [1] for a survey on numerical methods for trajectory generation, including their pros and cons. A third approach (hybrid approach) aims at developing methods that exploit the advantages of both of the above approaches [6][17].

Real-time solution of constrained OC problems is considered via a direct method. Although this approach extends to more general problems, this example relates to differentially flat systems and considers a piecewise polynomial parameterizations of the decision variables of the OC problem using NURBS basis functions. Differentially flat systems include controllable linear systems, and nonlinear systems which are feedback linearizable either by static or dynamic feedback [5]. Moreover, an aircraft in forward flight and a class of vertical take-off and landing (VTOL) aircraft as well as fully and certain underactuated spacecraft may be approximated by differentially flat systems. Trajectory generation for differentially flat systems has been conducted by various authors more notably [11], [4] and [10]. In [10], the issue of real-time trajectory generation was tackled successfully by the use of a direct method and B-spline parameterization of the flat outputs. In [4], the feasible region was approximated by a single polytope. Needless to say, depending on the number of obstacles and their position in space, this can be very conservative. In this example, both of these results are extended by retaining the real-time capabilities of [10] and allowing the inner approximation of the feasible region with respect to trajectory constraints by a union of convex polytopes. In order to relieve the burden often associated with direct methods, the properties of both differentially flat systems and NURBS basis functions are exploited to induce a transformation of the original OC problem into a simpler, more favorable numerical computational form. This is accomplished by effectively removing the dynamic and trajectory constraints from the original OC problem. As previously determined by other authors [5], for differentially flat systems there exists a set of flat outputs (equal in number to the inputs) such that all states and inputs can be determined from these outputs without integration. Consequently, the OC problem may be rewritten in terms of the flat outputs and then find a minimizer in the so-called flat-output space. Since the flat outputs implicitly contain all the information about the dynamics of the system, by introducing this transformation, no explicit dynamic constraints remain in the transformed OC problem (removal of dynamic constraints). Further parameterization of these flat outputs by NURBS basis functions allows exploitation of the fact that NURBS basis functions depend on two sets of parameters (control points and weights) and that one set of parameters (control points) may be used to specify, off-line, a region of space that automatically satisfies the trajectory constraints and which, in addition, guarantees that the generated trajectories will never leave this region (removal of trajectory constraints).

After these transformations, the original OC problem has been converted into a modified OC problem without dynamic and trajectory constraints. The modified OC problem is then transcribed to a Nonlinear Programming (NLP) problem with the remaining parameters (weights) as the decision variables. In summary, this approach consists of the following steps: a) Re-write the original OC problem in terms of the flat outputs (removal of dynamic constraints) b) Parameterize the flat outputs by piecewise polynomial functions using NURBS basis functions. c) Use the control points to specify off-line a region of space which is feasible with respect to trajectory constraints (removal of trajectory constraints) d) Transcribe the modified OC problem to an NLP problem with the weights as the decision variables. The present invention endeavors to solve optimal control (OC) problems with full generality. This is possible by optimizing with respect to the trajectory constraints separately from optimization with respect to the dynamic and actuator constraints.

A principal object of the present invention is to generate local optimal trajectories for dynamic systems, which are guaranteed to be feasible with respect to trajectory constraints, by parameterizing decision variables by Non-Uniform Rational B-Splines (NURBS) and judiciously exploiting their properties. In particular, the invention uses this parameterization to define a feasible corridor (a union of convex polytopes constructed by a finite set of vertices) a priori, guaranteeing that trajectories generated, thereafter, will remain inside the prescribed region.

The novelty of the approach resides in part in the ability to divide the trajectory generation procedure into two steps: a) construction of a feasible region with respect to trajectory constraints using convex polytopes and b) generation of local optimal trajectories mindful of such construction, which are guaranteed to remain inside the prescribed region and which are also feasible with respect to dynamic and actuator constraints.

One embodiment of the method of the invention may be defined as comprising the steps of (a) determining all feasible corridors through trajectory space and determining the optimal corridor with respect to a desired objective; (b) using a NURBS (non-uniform rational B-splines) parameterization to construct an approximation to the optimal corridor; (c) generating trajectories that ‘live’ in the optimal corridor, without explicitly considering trajectory constraints; and then (d) generating a local optimal trajectory also living in the optimal corridor. The local optimal trajectory is also feasible with respect to dynamic and actuator constraints. The resulting trajectory is, therefore, guaranteed to remain inside the prescribed region of feasible corridors, and is feasible with respect to trajectory constraints as well as dynamic and actuator constraints.

As illustrated by way of example in the drawings, the present invention is concerned with trajectory planning, which may be applied in various contexts, such as space vehicle control in rendezvous, docking, launch and reentry procedures, or in the control of terrestrial or airborne vehicles. In the past, trajectory planning techniques have focused either on consideration of trajectory constraints (usually in the form of obstacles), or on consideration of dynamic and actuator constraints associated with the vehicle or object being controlled. In accordance with the present invention, trajectory generation is divided into two distinct steps, one of which constructs a feasible region of trajectories that satisfy the trajectory constraints, and the other of which generates a local optimal trajectory that falls within the feasible region and is also feasible with respect to dynamic and actuator constraints.

The accompanying drawings in FIGS. 1-4 illustrate an embodiment of the invention as applied to an unmanned aerial vehicle (UAV) 102. Recall that one goal of the invention is to generate trajectories for dynamical systems that avoid obstacles present in trajectory space.

As indicated in FIG. 1, a global solver is used to determine all feasible corridors through a trajectory space 104 and to single out the optimal corridor with respect to some objective. The feasible corridors in this example comprise corridors 106, 108, 110, and 112. The global solver takes into account the trajectory constraints, such as obstacles 114, and possibly some simplified version of the dynamics of the vehicle. In order to obtain a global solution, the structure of the optimal control (OC) problem is exploited (typically, convexity). The various curved lines passing between adjacent obstacles illustrate several of the possible paths between a starting point and a destination point for the vehicle. The solid line represents the selected optimal path in this example.

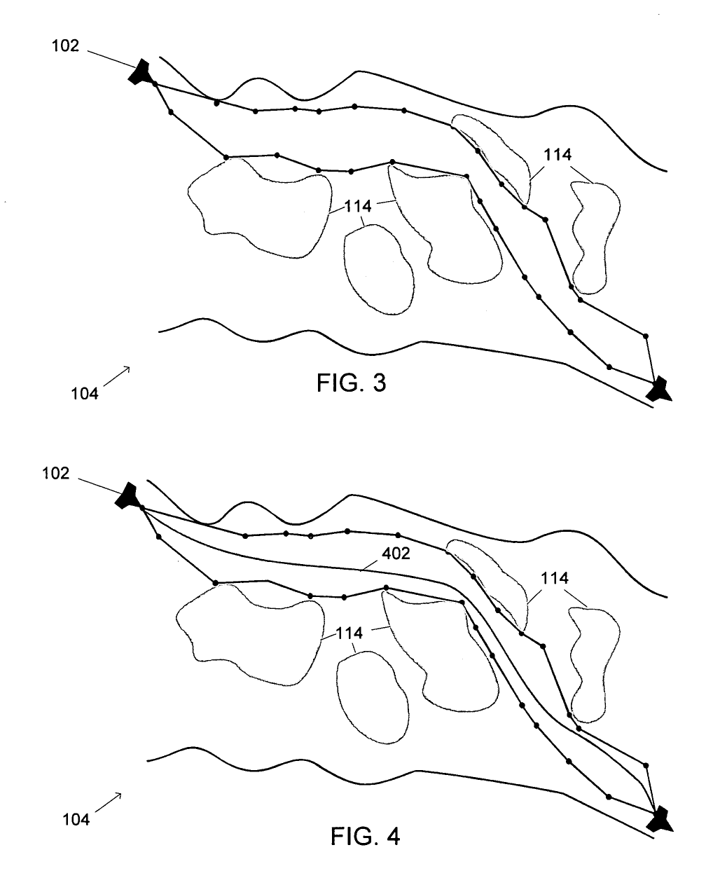

FIG. 2 illustrates that a NURBS parameterization is used to construct an approximation to the optimal region determined in accordance with FIG. 1. The introduction of NURBS basis functions allows the use of two types of parameters: weights and control points. The control points are used for approximating the optimal region isolated by the steps shown in FIG. 1, while the weights are used later to generate trajectories that are guaranteed to never leave the prescribed region. This step of the method exploits the fact that piecewise polynomial functions defined by NURBS basis functions are guaranteed to remain inside the convex hull of the control points defining each polynomial piece. As a result of smoothness requirements imposed on the decision variables, these convex sets (convex hulls) overlap, producing a connected region 202 as shown in FIG. 2. The union of convex polytopes in FIG. 2 approximates the optimal corridor.

The feasible corridor constructed in accordance with FIG. 2 allows the generation of trajectories that ‘live’ in this region and it simplifies the trajectory generation optimization by not being required to explicitly consider the trajectory constraints as depicted in FIG. 3. The specification of a feasible corridor in this way allows removal of the explicit trajectory constraints from the optimization.

Finally, a local optimal trajectory 402 living in this region is generated, as indicated in FIG. 4. This local optimal trajectory 402 is also made feasible with respect to dynamic and actuator constraints, by using the NURBS weights as decision variables as shown. The optimal trajectory that also is feasible with respect to the all other remaining constraints is obtained by trajectory generation. The resulting curve is guaranteed to remain inside the prescribed region.

An illustrative description of operation of the method is presented, for explanatory purposes. Consider the following general OC problem subject to control and state constraints:

$${min}_{x , u} J [ x , u ] = {g}_{0} ( x ( {t}_{0} ) , u ( {t}_{0} ) ) + {\int }_{{t}_{0}}^{{t}_{f}} {g}_{t} ( x ( t ) , u ( t ) ) ⅆ t + {g}_{f} ( x ( {t}_{f} ) , u ( {t}_{f} ) ) \qquad ( 1 )$$

Subject to:
\dot{x}=F(x(t),u(t)),t∈[t₀,t_{ƒ]} (2)
l₀≦A₀x(t₀)+B₀u(t₀)≦u₀
lₜ≦Aₜx(t)+Bₜu(t)≦uₜ,t∈[t₀,t_{ƒ]}
l_{ƒ}≦A_{ƒ}x(t_{ƒ})+B_{ƒ}u(t_{ƒ)≦}u_{ƒ} (3)
L₀≦c₀(x(t₀),u(t₀))≦U₀
Lₜ≦cₜ(x(t),u(t))≦Uₜ,t∈[t₀,t_{ƒ}]
L_{ƒ}≦c_{ƒ}(x(t_{ƒ}),u(t_{ƒ}))≦U_{ƒ}
where x(t) ∈ χ ⊂ Rⁿ and u(t) ∈ U ⊂ R^{m}. Furthermore, assume that all the involved functions are sufficiently smooth and of the appropriate dimensions.

Removal of Dynamic Constraints

As mentioned before, we will only consider differentially flat systems. In this particular case, there exist flat outputs z ∈ R^{m} of the form
z=Ψ(x,u⁽⁰⁾,u⁽¹⁾, . . . ,u^{(r)}) (4)
such that states and inputs can be written as Follows:
z=χ( Z̅₁, . . . , Z̅ₘ) (5)
u=μ( Z̅₁, . . . , Z̅ₘ) (6)
where Z̅₁=(Zᵢ⁽⁰⁾, . . . ,Zᵢ^{(D}^{ₜ}⁾) ∈ R^{N}^{₁}^{¹⁷}, Since the behavior of flat systems is determined by the flat outputs, we can plan trajectories in flat space and then map these to appropriate inputs.

With this transformation, the OC problem can be rewritten as follows:

$${min}_{\tilde{z}} J [ \tilde{z} ] = {G}_{0} ( \tilde{z} ( {t}_{0} ) ) + {\int }_{{t}_{0}}^{{t}_{f}} {G}_{t} ( \tilde{z} ( t ) ) ⅆ t + {G}_{f} ( \tilde{z} ( {t}_{f} ) )$$

Subject to:
l₀≦A₀ Z̅(t₀)≦u₀
lₜ≦Aₜ Z̅(t)≦uₜ,t∈[t₀,t_{ƒ}]
l_{ƒ}A_{ƒ} Z̅(t_{ƒ})≦u_{ƒ}
L₀≦C₀( Z̅(t₀))≦U₀
Lₜ≦Cₜ( Z̅(t))23 Uₜ,t∈[t₀,t_{ƒ}]
L_{ƒ}≦C_{ƒ}( Z̅(t_{ƒ}))≦U_{ƒ}
where X̅: [t₀,t_{ƒ}] → Rⁿ^{^{u}} is the total number of variables required for the problem; Z̅(t)=( Z̅₁(t), . . . , Z̅ₘ(t))∈ R^{N}^{^{u}}.

Parameterization of Flat Outputs

The search for minimizers is then restricted to the space of piecewise polynomial functions, P. More specifically, the search is restricted to functions with a prescribed number of polynomial pieces, order and smoothness. This space is identified by P_{b,o,s}, where b=(b0, . . . , b_{Np}) are the (Nₚ+1) breakpoints, specifying the sites at which the endpoints of the Nₚ polynomial pieces of order o being joined with smoothness sⱼ=s, j=1, . . . Nₚ−1 reside. This space is finite dimensional and it can be efficiently represented in terms of B-spline basis functions [3]. The dimension of the space is obtained by

$$dim ( {P}_{b , o , s} ) = {N}_{c} = {N}_{p} o - {\sum }_{i = 0}^{{N}_{p}} ( {s}_{j} + 1 ) \qquad ( 7 )$$

Consequently, a curve ^{c(t)∈P}^{_{b,o,s}} can be expressed in terms of the B-splines basis functions as follows:

$$\begin{matrix}{c}^{( r )} ( t ) = {\sum }_{i = 0}^{{N}_{c} - 1} {B}_{j , d}^{( r )} ( t ) {p}_{j} , & t ∈ [ {t}_{0} , {t}_{f} ] , & r = 0 , … , s\end{matrix} \qquad ( 8 )$$

where B_{j,d}(t) is the jth B-spline basis function of degree d and pⱼ is the corresponding jth control point. The B-spline basis functions are computed recursively:

For degree =0:

$${B}_{j , 0} ( t ) = \{ \begin{matrix}1 & if t ∈ [ {k}_{j} ; {k}_{j + 1} ) \\ 0 & otherwise\end{matrix}$$

For degree >0:

$${B}_{j , d} ( t ) = \frac{t - {k}_{j}}{{k}_{j + d} - {k}_{j}} {B}_{j , d - 1} ( t ) + \frac{{k}_{j + d + 1} - t}{{k}_{j + d + 1} - {k}_{j + 1}} {B}_{j + 1 , d - 1} ( t )$$

and the rth time derivative of the basis function B_{j,d}(t) is given by:

$${B}_{j , d}^{r} ( t ) = d ( \frac{{B}_{j , d - 1}^{r - 1} ( t )}{{k}_{j + d} - {k}_{j}} - \frac{{B}_{j + 1 , d - 1}^{r - 1} ( t )}{{k}_{j + d + 1} - {k}_{j + 1}} )$$

where kⱼ are the non-periodic knotpoints. That is, the knotpoints are constructed by repeating the breakpoint j, mⱼ times. mⱼ is the multiplicity of the particular breakpoint and is defined by mⱼ=d−sⱼ in general. In this case, the end breakpoints are discontinuous (mⱼ=d+1, j={0,Nₚ}) and the internal breakpoints are s continuous (mⱼ=d−s, j={1, . . . , Nₚ−1}). The non-periodic knotpoints then take the form:
k=(b₀¹, . . . ,b₀^{d=1}, . . . ,bᵢ¹, . . . ,bᵢ^{d-s}, . . . ,b_{N}_{ₚ}¹, . . . ,b_{N}_{ₚ}^{d+1})

Instead of B-spline basis functions, NURBS basis functions are used, which are themselves defined in terms of B-splines. Therefore, all the B-spline definitions above are required for their development. A curve c(t) is expressed in terms of NURBS basis functions as follows:

$$\begin{matrix}{c}^{( r )} ( t ) = {\sum }_{j = 0}^{{N}_{c} - 1} {R}_{j , d}^{( r )} ( t ) {p}_{j} , & & t ∈ [ {t}_{0} , {t}_{f} ]\end{matrix} \qquad ( 9 )$$

where R_{j,d}^{(r)}(t) is the rth time derivative of the jth NURBS basis function of degree d and pⱼ are the corresponding jth control points. The NURBS basis functions are expressed in terms of B-spline basis functions:

$${R}_{j , d} ( t ) = \frac{{B}_{j , d} ( t ) {w}_{j}}{{\sum }_{i = 0}^{{N}_{c} - 1} {B}_{i , d} ( t ) {w}_{i}} \qquad ( 10 )$$

where wⱼ>0 is the jth weight corresponding to the jth control point. By introducing, NURBS basis functions the number of decision parameters available is increased: weights in addition to control points. This increase allows the use of control points for defining a feasible region with respect to the trajectory constraints while using the weights to generate feasible trajectories that are guaranteed to never leave this region.

NURBS basis functions have many useful properties. In particular, they are nonnegative, satisfy the partition of unity property, have local support, remain in the convex hull of the control points, and all their derivatives exist in the interior of a knot span, [k₁, k₁+1), where they are rational functions with nonzero denominator [14].

Parameterizing the flat outputs and their derivatives in this manner provides:

$${\tilde{z}}_{i} ( t ) = \underbrace{[ \begin{matrix}{R}_{0 , {d}_{t}}^{0} ( t ) & … & {R}_{{N}_{c}^{t} - 1 , {d}_{t}}^{( 0 )} ( t ) \\ ⋮ & ⋰ & ⋮ \\ {R}_{0 , {d}_{t}}^{( {D}_{t} )} ( t ) & … & {R}_{{N}_{c}^{t} - 1 , {d}_{t}}^{( {D}_{t} )} ( t )\end{matrix} ]}_{ {\tilde{R}}_{{d}_{t}} ( t , {w}^{t} ) } \underbrace{[ \begin{matrix}{p}_{0}^{i} \\ ⋮ \\ {p}_{{N}_{c}^{t} - 1}^{i}\end{matrix} ]}_{{p}^{t}}$$

$$and$$

$$\tilde{z} ( t ) = \underbrace{[ \begin{matrix}{\tilde{R}}_{{d}_{1}} ( t , {w}^{1} ) & … & 0 \\ ⋮ & ⋰ & ⋮ \\ 0 & … & {\tilde{R}}_{{d}_{m}} ( t , {w}^{m} )\end{matrix} ]}_{ \tilde{R} ( t , \tilde{w} ) } \underbrace{[ \begin{matrix}{p}^{1} \\ ⋮ \\ {p}^{m}\end{matrix} ]}_{ \tilde{p} }$$

$$where \tilde{w} = ( {w}^{1} , … , {w}^{m} )$$

Removal of Trajectory Constraints

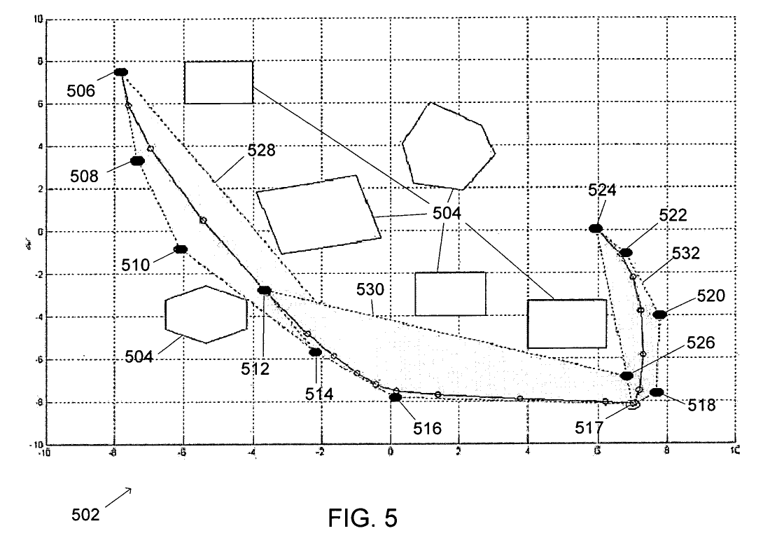

In general, trajectories that avoid obstacles present in trajectory space are desirable. Some of the constraints defined thus far in the OC problem are of this type. One goal is to construct a corridor through free space. That is, a region defined in such a way that any trajectory in it avoids such obstacles, or rather, it satisfies the trajectory constraints. Advantageously, piecewise polynomial functions defined by NURBS basis functions are guaranteed to remain inside the convex hull of the control points defining each polynomial piece. As a result of smoothness requirements imposed on the flat outputs, these convex sets (convex hulls) overlap, producing a connected region. This method makes use of two important properties of NURBS: the convex hull property and the local support property. As a consequence, the region being defined by the control points will be a union of Nₚ convex hulls. The goal then is to position the control points in such a way that the generated set specifies a region through trajectory space that satisfies all the trajectory constraints (avoids all obstacles), see FIG. 5. Since the resulting trajectory, if it exists, is guaranteed to remain inside this region, these constraints can effectively be removed from the OC Problem. The weights associated with these control points will be used as decision variables to generate a trajectory inside this region.

Referring to FIG. 5, a trajectory space 502 comprises a plurality of obstacles 504. A plurality of control points 506, 508, 510, 512, 514, 516, 517, 518, 520, 522, 524, and 526 form three overlapping convex hulls 528, 530, and 532. For example, convex hull 528 comprises control points 506, 508, 510, 514, and 516, convex hull 530 comprises control points 512, 514, 516, 517, 518, and 526, and convex hull 532 comprises control points 517, 518, 520, 522, 524, and 526. In this example, a desired trajectory for the UAV 102 may begin at point 506 and end at point 524.

Discretization of Modified OC Problem

Consider the following uniform time partition:
T₀=T₀<T₁<. . . T_{N}_{_{T-2}}<T_{N}_{_{T-1}}=t_{ƒ}

where

$${τ}_{i} = {t}_{0} + i Δ τ , \qquad i = 0 , … , {N}_{τ} - 1 , \qquad Δ τ = \frac{{t}_{f} - {t}_{0}}{{N}_{τ} - 1}$$

Then a discrete version of the optimal control problem may be written as follows:

$${min}_{\tilde{z}} J [ \tilde{z} ] = {G}_{0} ( \tilde{z} ( {τ}_{0} ) ) + {\sum }_{i = 0}^{{N}_{τ} - 2} [ {\sum }_{j = 0}^{N} {γ}_{j}^{i} {G}_{t} ( \tilde{z} ( {r}_{j} ) ) ] + {G}_{f} ( \tilde{z} ( {τ}_{{N}_{τ} - 1} ) )$$

Subject to:
l₀≦Ã₀\tilde{Z}(τ₀)≦u₀
lₜ≦Ãₜ\tilde{Z}(τᵢ)≦uₜ,i=), . . . ,N_{T}−1
l_{ƒ}Ã_{ƒ}\tilde{Z}(τ_{N}_{_{T-1}})≦u_{ƒ}
L₀≦\tilde{C}₀(\tilde{Z}(τ₀))≦U₀
Lₜ≦\tilde{C}ₜ(\tilde{Z}(τᵢ))≦Uₜ,i=0, . . . ,N_{T}−1
L_{ƒ}≦\tilde{C}_{ƒ}(\tilde{Z}(τ_{N}_{_{T}}₁))≦U_{ƒ}

In addition, the integral has been approximated by a quadrature formula. For this purpose the nodes rⱼ=τ₁+jΔrᵢ for j 32 0, 1, . . . , N, and

$$Δ {r}_{i} = \frac{{τ}_{t + 1} - {τ}_{t}}{N} ,$$

are defined, where N is the number of points required by the quadrature formula being used.

At this point, all the B-spline basis functions can be obtained at the respective points of the time partition and the OC problem has only the weights and the control points as unknowns. Recall that since some of the control points have been used to describe a feasible region through trajectory space, these control points are fixed and will not be used as decision variables. However the corresponding weights will be used to generate the trajectory traversing the specified region.

Nonlinear Programming Problem

Effectively after all these transformations, the original OC problem has been transcribed into an NLP problem. At this point, any NLP solver can be used to solve this problem. For this example, the SNOPT solver [7] has been used. SNOPT uses a Sequential Quadratic Programming (SQP) algorithm and it has been optimized to solve general Sparse NLP problems cast in the following form:

$${min}_{y} f ( y )$$

Subject to:

$$L \leq [ \begin{matrix}y \\ C ( y ) \\ A y\end{matrix} ] \leq U$$

in this case the unknowns are the weights and control points defining the flat outputs; therefore,

$$y = [ \begin{matrix}\tilde{p} \\ \tilde{w}\end{matrix} ]$$

the cost function

$$f ( y ) = {G}_{0} ( \tilde{z} ( {τ}_{0} ) ) + {\sum }_{i = 0}^{{N}_{τ} - 2} [ {\sum }_{j = 0}^{N} {γ}_{j}^{i} {G}_{t} ( \tilde{z} ( {r}_{j} ) ) ] + {G}_{f} ( \tilde{z} ( {τ}_{{N}_{τ} - 1} ) )$$

the nonlinear constraints

$$[ \begin{matrix}{L}_{0} \\ {L}_{t} \\ ⋮ \\ {L}_{t} \\ {L}_{f}\end{matrix} ] \leq [ \begin{matrix}{\tilde{C}}_{0} ( \tilde{z} ( {τ}_{0} ) ) \\ {\tilde{C}}_{t} ( \tilde{z} ( {τ}_{0} ) ) \\ ⋮ \\ {\tilde{C}}_{t} ( \tilde{z} ( {τ}_{{N}_{τ} - 1} ) ) \\ {\tilde{C}}_{0} ( \tilde{z} ( {τ}_{{N}_{τ} - 1} ) )\end{matrix} ] \leq [ \begin{matrix}{U}_{0} \\ {U}_{t} \\ ⋮ \\ {U}_{t} \\ {U}_{f}\end{matrix} ]$$

and the linear constraints

$$[ \begin{matrix}{l}_{0} \\ {l}_{t} \\ ⋮ \\ {l}_{t} \\ {l}_{f}\end{matrix} ] \leq [ \begin{matrix}{\tilde{A}}_{0} \tilde{z} ( {τ}_{0} ) \\ {\tilde{A}}_{t} \tilde{z} ( {τ}_{0} ) \\ ⋮ \\ {\tilde{A}}_{0} \tilde{z} ( {τ}_{{N}_{τ} - 1} ) \\ {\tilde{A}}_{f} \tilde{z} ( {τ}_{{N}_{τ} - 1} )\end{matrix} ] \leq [ \begin{matrix}{u}_{0} \\ {u}_{t} \\ ⋮ \\ {u}_{t} \\ {u}_{f}\end{matrix} ]$$

In order to obtain a minimizer for the NLP problem, the Jacobians of the involved functions must be calculated with respect to the unknowns. In general, for any function F(\tilde{Z}(τⱼ)) at any time τⱼ its Jacobian is obtained by using the chain rule to obtain:
D_{y}F(\tilde{Z}(τⱼ))=D_{\tilde{Z}}F(\tilde{Z}(τⱼ))D_{y}\tilde{Z}(τⱼ)

The partial derivatives with respect to each of these parameters are expressed in the form

$$\frac{\partial {z}_{i} ( t , {w}^{i} , {p}^{i} )}{\partial t} = \frac{\partial }{\partial t} [ \frac{{\sum }_{j = 0}^{{N}_{c}^{t} - 1} {B}_{j , {d}_{t}} ( t ) {w}_{j}^{i} {p}_{j}^{i}}{{\sum }_{i = 0}^{{N}_{c}^{t} - 1} {B}_{i , {d}_{t}} ( t ) {w}_{i}^{i}} ]$$

$${D}_{{w}^{i}} {z}_{i} ( t , {w}^{i} , {p}^{i} ) = [ \begin{matrix}\frac{\partial {z}_{i} ( t , {w}^{i} , {p}^{i} )}{\partial {w}_{0}^{i}} & … & \frac{\partial {z}_{i} ( t , {w}^{i} , {p}^{i} )}{\partial {w}_{{N}_{0}^{t} - 1}^{i}}\end{matrix} ]$$

$${D}_{{p}^{i}} {z}_{i} ( t , {w}^{i} , {p}^{i} ) = [ \begin{matrix}\frac{\partial {z}_{i} ( t , {w}^{i} , {p}^{i} )}{\partial {p}_{0}^{i}} & … & \frac{\partial {z}_{i} ( t , {w}^{i} , {p}^{i} )}{\partial {p}_{{N}_{0}^{t} - 1}^{i}}\end{matrix} ]$$

where the individual derivatives are obtained from

$${z}_{i}^{( r )} ( t , {w}^{i} , {p}^{i} ) = \frac{{\sum }_{j = 0}^{{N}_{c}^{t} - 1} {B}_{j , {d}_{t}}^{( r )} ( t ) {w}_{j}^{i} {p}_{j}^{i}}{{\sum }_{j = 0}^{{N}_{c}^{t} - 1} {B}_{j , {d}_{t}} ( t ) {w}_{j}^{i}} - {\sum }_{l = 1}^{r} ( \begin{matrix}r \\ l\end{matrix} ) {Ψ}_{i}^{l} {z}_{i}^{( r - l )} ( t , {w}^{i} , {p}^{i} )$$

$$\frac{\partial {z}_{i}^{( r )} ( t , {w}^{i} , {p}^{i} )}{\partial {w}_{k}^{i}} = {Φ}_{i}^{r} - {Φ}_{i}^{0} {z}_{i}^{( r )} ( t , {w}^{i} , {p}^{i} ) - {\sum }_{l = 1}^{r} ( \begin{matrix}r \\ l\end{matrix} ) {Φ}_{i}^{l} {z}_{i}^{( r - l )} ( t , {w}^{i} , {p}^{i} ) - {\sum }_{l = 1}^{r} ( \begin{matrix}r \\ l\end{matrix} ) {Ψ}_{i}^{l} \frac{\partial {z}_{i}^{( r - l )} ( t , {w}^{i} , {p}^{i} )}{\partial {w}_{k}^{i}}$$

$$\frac{\partial {z}_{i}^{( r )} ( t , {w}^{i} , {p}^{i} )}{\partial {p}_{k}^{i}} = {Φ}_{i}^{r} - {\sum }_{l = 1}^{r} ( \begin{matrix}r \\ l\end{matrix} ) {Ψ}_{i}^{l} \frac{\partial {z}_{i}^{( r - l )} ( t , {w}^{i} , {p}^{i} )}{\partial {p}_{k}^{i}}$$

$$\begin{matrix}where {Ψ}_{i}^{l} = \frac{{\sum }_{j = 0}^{{N}_{c}^{t} - 1} {B}_{j , {d}_{t}}^{( l )} ( t ) {w}_{j}^{i}}{{\sum }_{j = 0}^{{N}_{c}^{t} - 1} {B}_{j , {d}_{t}} ( t ) {w}_{j}^{i}} , & {Φ}_{i}^{l} = \frac{{B}_{{t}_{i} , {d}_{j}}^{( l )} ( t )}{{\sum }_{j = 0}^{{N}_{c}^{t} - 1} {B}_{j , {d}_{t}} ( t ) {w}_{j}^{i}}\end{matrix} .$$

### EXAMPLE

### VTOL UAV

In this section, a combination of FORTRAN and C++ is used for implementation of the method to plan trajectories for a small four-propeller vertical take-off and landing (VTOL) unmanned aerial vehicle (UAV) 602. Assuming a flat-Earth approximation and near-hover dynamics (aerodynamic forces and moments are negligible), Newton's law and Euler's law for the VTOL UAV in local-level coordinates and body coordinates may be written, respectively, as follows:

$$\begin{matrix}{[ \frac{ⅆ {v}_{B}^{{F}_{E}}}{ⅆ t} ]}^{L} = {{\frac{1}{m} [ {T}^{T} ]}^{BL} [ {F}_{p} ]}^{B} - {[ g ]}^{L} \\ {[ \frac{ⅆ {ω}^{{F}_{B} / {F}_{E}}}{ⅆ t} ]}^{B} = {{[ {I}_{B}^{{F}_{B} - 1} ]}^{B} [ {M}_{p} ]}^{B} - {{{{[ {I}_{B}^{{F}_{B} - 1} ]}^{B} [ {Ω}^{{F}_{B} / {F}_{E}} ]}^{B} [ {I}_{B}^{{F}_{B}} ]}^{B} [ {ω}^{{F}_{B} / {F}_{E}} ]}^{E} \\ where \\ \begin{matrix}{[ {v}_{B}^{{F}_{E}} ]}^{L} = [ \begin{matrix}\dot{x} \\ \dot{y} \\ \dot{z}\end{matrix} ] , & {[ g ]}^{L} = [ \begin{matrix}g \\ 0 \\ 0\end{matrix} ] , & {[ {F}_{p} ]}^{B} = [ \begin{matrix}F \\ 0 \\ 0\end{matrix} ]\end{matrix} \\ \begin{matrix}{[ {ω}^{{F}_{B} / {F}_{E}} ]}^{B} = [ \begin{matrix}p \\ q \\ r\end{matrix} ] , & {[ {Ω}^{{F}_{B} / {F}_{E}} ]}^{B} = [ \begin{matrix}0 & - r & q \\ r & 0 & - p \\ - q & p & 0\end{matrix} ]\end{matrix} \\ \begin{matrix}{[ {I}_{B}^{{F}_{B}} ]}^{B} = [ \begin{matrix}{I}_{x} & 0 & 0 \\ 0 & {I}_{y} & 0 \\ 0 & 0 & {I}_{z}\end{matrix} ] , & {[ {M}_{p} ]}^{B} = [ \begin{matrix}{M}_{{X}_{B}} \\ {M}_{{Y}_{B}} \\ {M}_{{Z}_{B}}\end{matrix} ]\end{matrix} \\ {[ {T}^{T} ]}^{BL} = [ \begin{matrix}c θ c ψ & s θ s ϕ c ψ - s ψ c ϕ & s θ c ϕ c ψ + s ψ s ϕ \\ c θ s ψ & s ψ s θ s ϕ + c ψ c ϕ & s ψ s θ c ϕ - c ψ s ϕ \\ - s θ & s ϕ c θ & c ϕ c θ\end{matrix} ]\end{matrix}$$

with c and s being used instead of cos and sin, correspondingly. (x,y,z) denotes the position of the center of mass of the UAV. The magnitude of applied force along the X_{B} body axis is denoted F. The mass of the UAV is m=2.0 kg, g is gravity, and p, q, and r are the components of the angular velocity in body coordinates. Moreover, it is assumed that there are no products of inertia. The principle moments of inertia are denoted as follows: Iₓ=0.25 kg m², I_{y}=0.125 kg m², and I_{Z}=0.125 kg m². The equations of motion become in these coordinates:

$$\begin{matrix}[ \begin{matrix}\ddot{x} + y \\ \ddot{y} \\ \ddot{z}\end{matrix} ] = \frac{F}{m} [ \begin{matrix}cos θ cos ψ \\ cos θ sin ψ \\ - sin θ\end{matrix} ] \\ [ \begin{matrix}\dot{p} \\ \dot{q} \\ \dot{r}\end{matrix} ] = [ \begin{matrix}( 1 / {I}_{x} ) [ {M}_{{X}_{B}} + ( {I}_{y} - {I}_{z} ) q r ] \\ ( 1 / {I}_{y} ) [ {M}_{{Y}_{B}} + ( {I}_{z} - {I}_{x} ) p r ] \\ ( 1 / {I}_{z} ) [ {M}_{{Z}_{B}} + ( {I}_{x} - {I}_{y} ) p q ]\end{matrix} ]\end{matrix}$$

Consider the minimum time OC problem of taking the VTOL UAV from an initial equilibrium solution to a final equilibrium solution subject to obstacle constraints and input constraints.

$$\begin{matrix}{min}_{x , u} {\int }_{{t}_{0}}^{{t}_{f}} ⅆ t & ( 11 ) \\ \dot{x} = f ( x , u ) & ( 12 ) \\ ( x ( {t}_{0} ) , x ( {t}_{f} ) ) ∈ B & ( 13 ) \\ ( x ( t ) , y ( t ) , z ( t ) ) ∈ S & ( 14 ) \\ u ( t ) ∈ U & ( 15 )\end{matrix}$$

where the states x=(x,\dot{x},y,\dot{y},z,\dot{z},Φ,\dot{Φ},θ,\dot{θ},Ψ,\dot{Ψ}) and the inputs u=(F_{L}, F_{R}, F_{F}, F_{B}). This system is differentially flat. The flat outputs are:
z₁=x,z₂=y,z₃=z,z₄=Φ

The flat outputs may be written in terms of the states, inputs, and their derivatives as follows:
z₁⁽¹⁾=\dot{x}z₁⁽²⁾=F(cos θcos Ψ)−g
z₂⁽¹⁾=\dot{y}z₂⁽²⁾=F(cosθsinΨ)
z₃⁽¹⁾=\dot{z}z₃⁽²⁾=−Fsinθ
z₄⁽¹⁾=\dot{Φ}z₄⁽²⁾=ƒ₁(Ψ,Φ, θ,\dot{Ψ},\dot{θ},\dot{Φ},M_{Xb},M_{Yb},M_{Zb})
z₁⁽³⁾=ƒ₂(F,\dot{F},Ψ,Φ,θ,\dot{Ψ},\dot{θ},\dot{Φ})
z₂⁽³⁾=ƒ₃(F,\dot{F},Ψ,Φ,θ,\dot{Ψ},\dot{θ},\dot{Φ})
z₃⁽³⁾=ƒ₄(F,\dot{F},Ψ,Φ,θ,\dot{Ψ},\dot{θ},\dot{Φ})
z₁⁽⁴⁾=ƒ₅(F,\dot{F},\ddot{F},Ψ,Φ,θ,\dot{Ψ},\dot{θ},\dot{Φ},M_{Yb},M_{Zb})
z₂⁽⁴⁾=ƒ₆(F,\dot{F},\ddot{F},Ψ,Φ,θ,\dot{Ψ},\dot{θ},\dot{Φ},M_{Yb},M_{Zb})
z₃⁽⁴⁾=ƒ₇(F,\dot{F},\ddot{F},Ψ,Φ,θ,\dot{Ψ},\dot{θ},\dot{Φ},M_{Yb},M_{Zb}).

In short,
(z₁, . . . ,Z₂⁽⁴⁾,z₂, . . . ,z₂⁽⁴⁾,z₃, . . . ,z₃⁽⁴⁾,z₄, . . . ,z⁽²⁾)=Ψ(ξ),

where
ξ=(x,y,z,θ,Φ,Ψ,\dot{z},\dot{y},\dot{z},\dot{θ},\dot{Φ},\dot{Ψ},M_{Xb},M_{Yb},M_{Zb},F,\dot{F},\ddot{F}).

The above relation is locally invertible, with the exception of a few points, since

$$det ( \frac{\partial Ψ}{\partial ξ} ) = \frac{- {F}^{6} cos θ}{{I}_{x} {I}_{y} {I}_{z}} \qquad ( 16 )$$

is nonzero. For implementation purposes, the states and inputs must be explicitly written in terms of the flat outputs. Given that
x=z₁,y=z₂,z=z₃,Φ=z₄

and consequently

$$\begin{matrix}\begin{matrix}\dot{x} = {\dot{z}}_{1} , & \dot{y} = {\dot{z}}_{2} , & \dot{z} = {\dot{z}}_{2} , & \dot{ϕ} = {\dot{z}}_{4}\end{matrix} \\ \begin{matrix}{x}^{( r )} = {z}_{1}^{( r )} , & {y}^{( r )} = {z}_{2}^{( r )} , & {z}^{( r )} = {z}_{3}^{( r )} , & {ϕ}^{( r )} = {z}_{r}^{( 4 )}\end{matrix}\end{matrix}$$

Using the equations of motion, Ψ, θ, F, M_{B}_{ₓ},M_{B}_{_{y}} and M_{B}_{_{z}} must then be written in terms of the flat outputs. Using Newton's law in flat-output space, Ψ, θ, and F can be solved analytically

$$\begin{matrix}ψ = {tan}^{- 1} ( \frac{{\ddot{z}}_{2}}{{\ddot{z}}_{1} + g} ) & ( 17 ) \\ θ = {tan}^{- 1} ( \frac{- {\ddot{z}}_{3}}{( {\ddot{z}}_{1} + g ) cos ψ + {\ddot{z}}_{2} sin ψ} ) & ( 18 ) \\ F = m \sqrt{{( {\ddot{z}}_{1} + g )}^{2} + {\ddot{z}}_{2}^{2} + {\ddot{z}}_{3}^{2}} & ( 19 )\end{matrix}$$

Likewise, using Euler's law in flat-output space, the propulsive moments M_{BX}, M_{By}, and M_{BZ} can be solved for as:
M_{B}_{ₓ}=Iₓ\dot{p}+(I_{z}−I_{y})qr (20)
M_{B}_{_{Y}}=I_{y}\dot{q}+(Iₓ−I_{z})pr (21)
M_{B}_{_{Z}}=I_{z}\dot{r}+(I_{y}−Iₓ)pq (22)

To write the moments in flat-output space, the components of the angular velocity in terms of Euler angles are written as:

$$[ \begin{matrix}p \\ q \\ r\end{matrix} ] = [ \begin{matrix}\dot{ϕ} - \dot{ψ} sin θ \\ \dot{θ} cos ϕ + \dot{ψ} cos θ sin ϕ \\ \dot{ψ} cos θ cos ϕ - \dot{θ} sin ϕ\end{matrix} ] \qquad ( 23 )$$

and after taking their time derivatives and substituting in equations (20)-(22):
M_{Bx}=ƒ_{Bx}(Iₓ,I_{y},I_{z},θ,Φ,\dot{θ},\dot{Φ},\dot{Ψ},\ddot{Φ},\ddot{Ψ})
M_{BY}=ƒ_{BY}(Iₓ,I_{y},I_{z},θ,Φ,\dot{θ},\dot{Φ},\dot{Ψ},\ddot{θ},\ddot{Ψ})
M_{BZ}=ƒ_{BZ}(Iₓ,I_{y},I_{z},θ,Φ,\dot{θ},\dot{Φ},\dot{Ψ},\ddot{Ψ})

The following variables are used: ^{Φ,\dot{Φ},\ddot{Φ},Ψ,\dot{Ψ},\ddot{Ψ},θ,\dot{θ}}, and ^{\ddot{θ}.} Since ^{Φ} is flat output,
Φ=z₄,\dot{Φ}=\dot{z}₄,\ddot{Φ}=\ddot{z}₄

The other derivatives can be obtained by taking time derivatives of equations (17) and (18). After these substitutions, the moments will depend only on the flat outputs and their time derivatives. Moreover, the individual fan forces F_{L}, F_{R}, and F_{B} may be obtained by inverting

$$[ \begin{matrix}{M}_{{X}_{B}} \\ {M}_{{Y}_{B}} \\ {M}_{{Z}_{B}} \\ F\end{matrix} ] = [ \begin{matrix}{k}_{w} & {k}_{w} & - {k}_{w} & - {k}_{w} \\ 0 & 0 & {l}_{F B} & - {l}_{F B} \\ {l}_{L R} & - {l}_{L R} & 0 & 0 \\ 1 & 1 & 1 & 1\end{matrix} ] [ \begin{matrix}{F}_{L} \\ {F}_{R} \\ {F}_{F} \\ {F}_{B}\end{matrix} ]$$

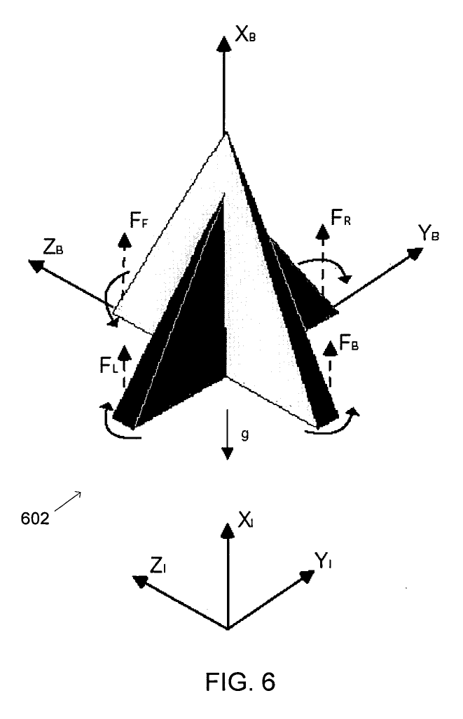

The applied thrust forces are fixed in the body as shown in FIG. 6. The torque constant of the propeller is k_{w}=0.5, I_{FB}=1.0 m is half the distance between the applied force F_{F} and F_{B}, and l_{LR}=1.0 m is half the distance between the applied force F_{L} and F_{R} as seen in FIG. 6.

After this transformation, equation (12) may be removed from the minimum OC problem. The flat outputs may then be parameterized by NURBS basis functions. In this example, piecewise polynomial functions P_{b,o,s} are chosen for each flat output. More specifically Z₁, . . . , Z₃ are P_{b,7,4,} with 16 polynomial pieces being pasted at the breakpoints b, where b is constructed by evenly positioning the end points of the polynomials in the interval [0, 1]. The flat output Z₄ is also constructed with 16 polynomials and the same breakpoints b except for a different order and curve smoothness: P_{b,6,3}.

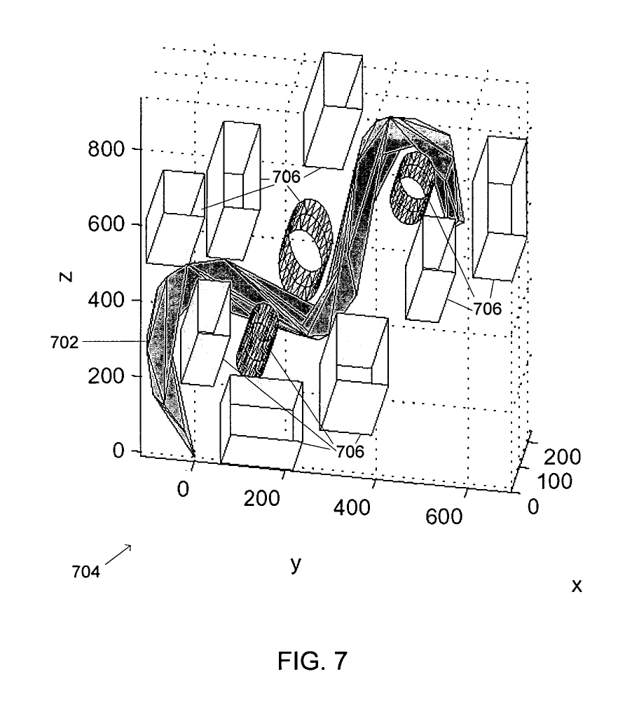

The next step is to construct a corridor 702 in S (trajectory space 704) which avoids all obstacles 706. This allows removal of equation (14) from the OC problem. FIG. 7 shows the corridor 702 that has been designed for this example.

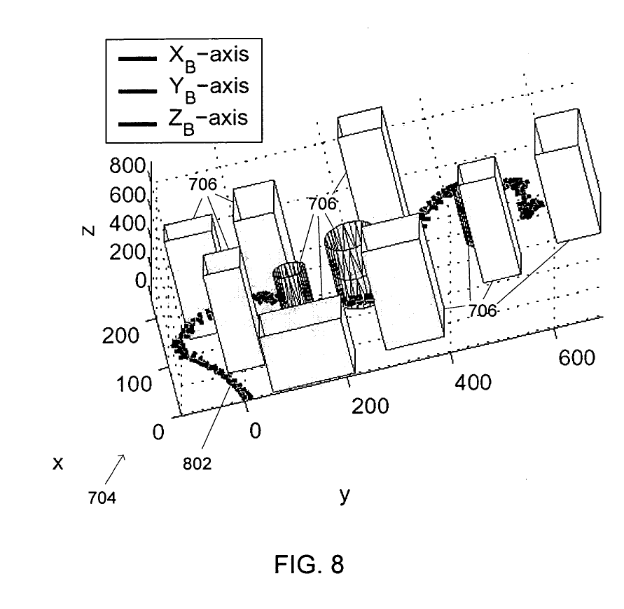

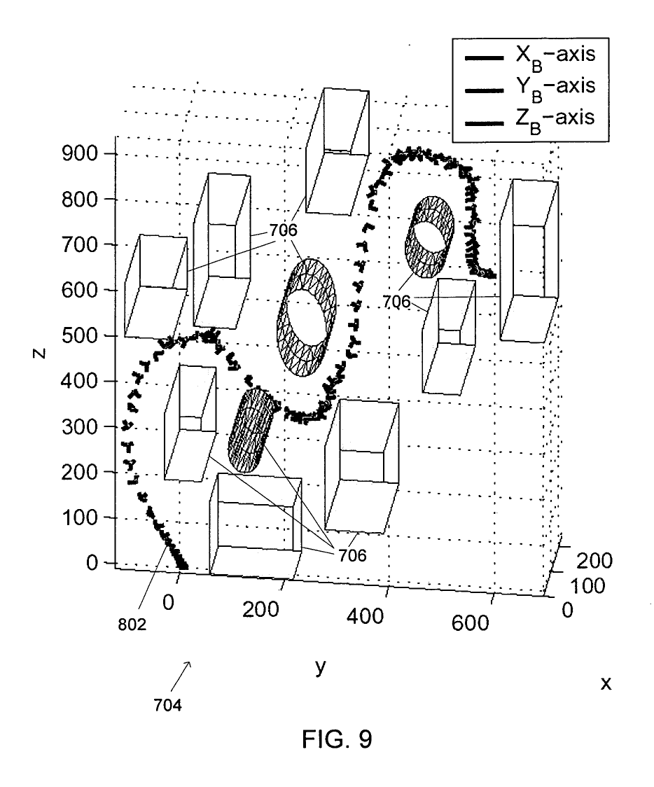

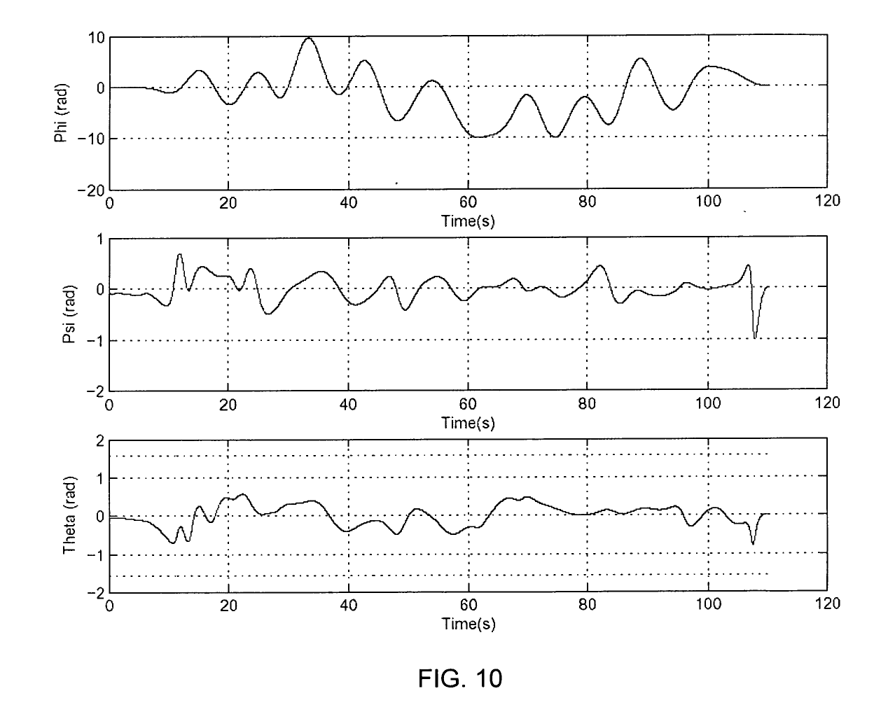

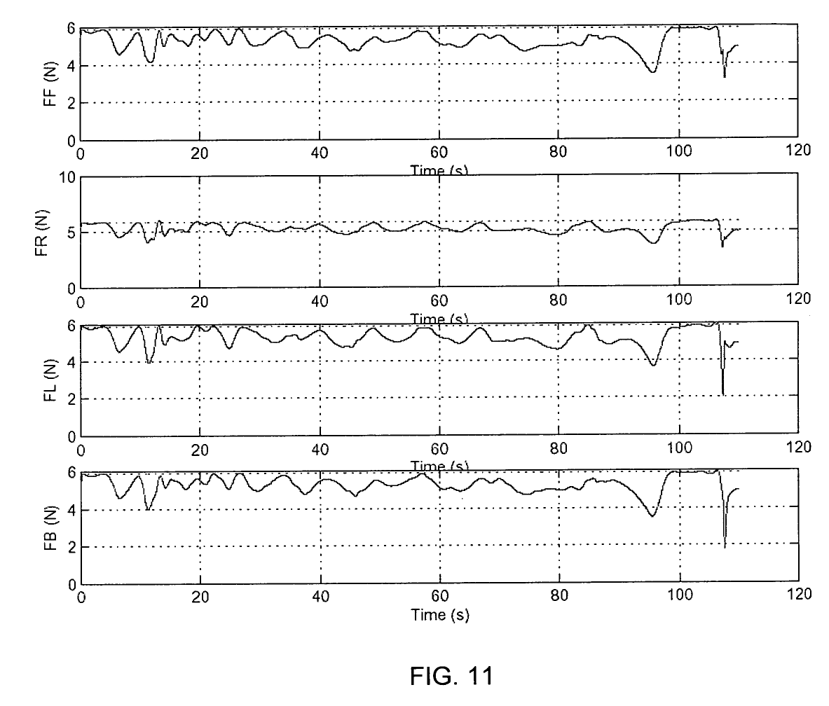

The only constraints remaining in this OC problem are equations (13) and (15). The body forces F_{F}, F_{R}, F_{L} and F_{B} are constrained to be in the interval [0, 0.3 m g]. The angle θ was further constrained to the interval [−π/2, π/2] to avoid the singularity described in equation (16). The optimal trajectory 802 was found starting from a random initial guess as shown in FIG. 8 (front view) and FIG. 9 (aerial view). The 109.97 second trajectory was solved in real time on a 3 GHz Pentium IV PC. The euler angles and body forces are shown in FIG. 10 and FIG. 11, respectively.

Conclusion

In conclusion, a new local trajectory generation method is introduced that exploits the intrinsic properties of both differentially flat systems and NURBS Basis functions to define OC problems that are amenable to real-time solution. The ability to decouple the trajectory generation problem from feasibility with respect to space obstacles allows the design of feasible regions a priori, guaranteeing that trajectories generated thereafter will remain inside the prescribed region and, in addition, are feasible (or infeasible) with respect to dynamic and actuator constraints. Moreover, the method is successfully applied to generate trajectories for a VTOL UAV that avoids obstacles in space. The results may be extended to take advantage of a global solver, to single out global corridors that are optimal with respect to a desired objective and then define regions in such corridors to generate feasible trajectories with respect to obstacle constraints. In addition, there exists the possibility of using such a method to design receding horizon controllers for systems with state constraints.

References

[1] J. T. Betts, Survey of Numerical Methods for Trajectory Optimization, J. of Guidance, Control, and Dynamics, 21(2):193-207, 1998.

[2] A. E. Bryson, Applied Optimal Control, Washington: Hemisphere Publishing Company, 1975.

[3] C. De Boor, A Practical Guide to Splines, New York: Springer-Verlag,1978.

[4] N. Faiz, S. K. Agrawal and R. M. Murray, Trajectory Planning of Differentially Flat Systems with Dynamics and Inequalities, J. of Guidance, Control and Dynamics, 24(2):219-227, 2001.

[5] M. Fliess, J. Levine, Ph. Martin and P. Rouchon, Flatness and defect of nonlinear systems: introductory theory and examples, Int. J. Control, 61(6):1327-1361, 1995.

[6] P. F. Gath, “CAMTOS-A software suite combining Direct and Inderect Trajectory Optimization Methods”. Universitat Stuttgart Dissertation 2002.

[7] P. Gill and W. Murray and M. Saunders, “User's Guide for SNOPT 7: A Fortran Package for Large-Scale Nonlinear Programming”. Systems Optimization Laboratory, Stanford University, Stanford, Calif. 94305.

[8] J. C. Latombe, Robot Motion Planning, Boston: Kluwer Academic Publishers, 1991.

[9] D. Kraft, On Converting Optimal Control Problems into Nonlinear Programming Codes, in: NATO ASI Series, Vol. F15, Computational Mathematical Programming, ed. K. Schittkowski, Springer, 1985.

[10] M. B. Milam, “Real-Time Optimal Trajectory Generation for Constrained Dyanamical Systems”. California Institute of Technology Dissertation 2003.

[11] M. J. van Nieuwstadt, “Trajectory Generation for Nonlinear Control Systems”. California Institute of Technology Dissertation 1996.

[12] H. Pesch, Real-time Computation of Feedback Controls for Constrained Optimal Control Problems. Part 1: Neighboring extremals, Optimal Control Applications and Methods, 10:129-145, 1989.

[13] H. Pesch, Real-time Computation of Feedback Controls for Constrained Optimal Control Problems. Part 2: A Correction Method based on Neighboring extremals, Optimal Control Applications and Methods, 10:147-171, 1989.

[14] L. Piegle and W. Tiller, The NURBS Book, 2nd edition, Germany: Springer-Verlag, 1997.

[15] L. S. Pontryagin, V. G. Boltyanskii, R. V. Gamkrelidze and E. F. Mischchenko, The Mathematical Theory of Optimal Processes, Wiley-Interscience, 1962.

[16] M. Rathinam, “Differentially Flat Nonlinear Control Systems”. California Institute of Technology Dissertation 1997.

[17] O. von Stryk and R. Bulirsch, Direct and Indirect Methods for Trajectory Optimization, Annals of Operations Research, 37:357-373, 1992.

What is claimed is:

1. A method, comprising the steps of:
approximating a feasible corridor with at least one convex polytope, wherein the at least one convex polytope is defined by a plurality of vertices, wherein the feasible corridor comprises a region in a trajectory space that satisfies a plurality of trajectory constraints for a vehicle to pass through the trajectory space, wherein the vehicle comprises a plurality of vehicle constraints;
constructing a non-uniform rational B-spline (NURBS) definition that comprises:
a plurality of NURBS basis functions,
a plurality of control points that comprise the plurality of vertices, and
a plurality of weight points;
parameterizing the plurality of vehicle constraints with the plurality of NURBS basis functions;
generating at least one trajectory for the vehicle through the trajectory space, wherein the at least on trajectory lies within the feasible corridor to satisfy the plurality of trajectory constraints.

2. The method of claim 1, further comprising the step of:
determining at least one available corridor through the trajectory space through employment of a global solver, wherein the at least one available corridor comprises the feasible corridor;
selecting the feasible corridor from the at least one available corridor.

3. The method of claim 1, wherein the plurality of vehicle constraints comprise at least one dynamic constraint that is defined by at least one decision variable;
wherein the step of parameterizing the plurality of vehicle constraints with the plurality of NURBS basis functions comprises the step of:
parameterizing the at least one decision variable in terms of the plurality of NURBS basis functions.

4. The method of claim 3, wherein the plurality of vehicle constraints comprise a differentially flat system, the method further comprising the step of:
rewriting the plurality of vehicle constraints in terms of at least one flat output of the differentially flat system.

5. The method of claim 1, wherein the step of generating the at least one trajectory for the vehicle through the trajectory space comprises the step of:
generating a local optimal trajectory within the feasible corridor.

6. The method of claim 5, wherein the feasible corridor comprises a first feasible corridor, the method further comprising the steps of:
choosing a second feasible corridor upon a failure of the generation of the local optimal trajectory;
inner approximating the second feasible corridor;
generating a local optimal trajectory within the second feasible corridor with respect to the at least one trajectory constraint.

7. The method of claim 1, wherein the step of approximating the feasible corridor with the at least one convex polytope comprises the step of:
inner approximating the feasible corridor by a union of a plurality of convex polytopes to remove the plurality of trajectory constraints, wherein the plurality of convex polytopes comprise the at least one convex polytope.

8. The method of claim 1, wherein the step of approximating the feasible corridor with the at least one convex polytope comprises the step of:
approximating the feasible corridor with a plurality of convex polytopes.

9. A method for generation of a trajectory for a vehicle through a trajectory space by solving an optimal control problem defined by at least one trajectory constraint for the trajectory space and at least one dynamic constraint for the vehicle, wherein the optimal control problem comprises a differentially flat system, the method comprising the steps of:
rewriting the optimal control problem in terms of flat outputs of the differentially flat system to remove the at least one dynamic constraint;
determining a feasible corridor for the vehicle through the trajectory space;
approximating the feasible corridor through employment of a non-uniform rational B-spline (NURBS) parameterization to remove the at least one trajectory constraint;
rewriting the optimal control problem as a non-linear programming problem with weights of the NURBS parameterization as decision variables;
solving the non-linear programming problem to generate a local optimal trajectory within the feasible corridor.

10. The method of claim 9, wherein the step of determining the feasible corridor for the vehicle through the trajectory space comprises the step of:
determining the feasible corridor for the vehicle through the trajectory space such that the at least one trajectory constraint is satisfied.

11. The method of claim 10, wherein the step of determining the feasible corridor for the vehicle through the trajectory space such that the at least one trajectory constraint is satisfied comprises the step of:
employing a global solver to determine the feasible corridor.

12. The method of claim 9, wherein the step of approximating the feasible corridor through employment of the non-uniform rational B-spline (NURBS) parameterization to remove the at least one trajectory constraint comprises the step of:
approximating the feasible corridor through employment of a plurality of piecewise polynomial functions.

13. The method of claim 12, wherein the step of approximating the feasible corridor through employment of the plurality of piecewise polynomial functions comprises the step of:
selecting at least one piecewise polynomial function such that the at least one piecewise polynomial function has a predetermined order and smoothness.

14. The method of claim 12, wherein the NURBS parameterization is defined by a plurality of control points and a plurality of weight points, wherein the step of approximating the feasible corridor through employment of the NURBS parameterization to remove the at least one trajectory constraint comprises the step of:
defining the feasible corridor by the plurality of control points.

15. The method of claim 12, wherein the NURBS parameterization is defined by a plurality of control points and a plurality of weight points, wherein the step of approximating the feasible corridor through employment of the NURBS parameterization to remove the at least one trajectory constraint comprises the step of:
defining the feasible corridor by a subset of the plurality of control points.

16. The method of claim 12, wherein the non-linear programming problem comprises a plurality of functions, wherein the step of solving the non-linear programming problem to generate the local optimal trajectory within the feasible corridor comprises the step of:
generating Jacobians for the plurality of functions.

17. A method, comprising the steps of:
rewriting an optimal control problem in terms of flat outputs of the optimal control problem to obtain a modified control problem;
defining a feasible corridor with respect to at least one trajectory constraint through employment of a plurality of control points of the NURBS basis functions;
parameterizing the flat outputs of the modified control problem by piecewise polynomial functions using non-uniform rational B-spline (NURBS) basis functions;
transcribing the modified control problem to a non-linear programming problem with weights of the NURBS basis functions as decision variables.

18. The method of claim 17, wherein the optimal control problem comprises a determination of a vehicle trajectory through a trajectory space, wherein the feasible corridor comprises a corridor through the trajectory space that satisfies the at least one trajectory constraint, the method further comprising the step of:
inner approximating the feasible corridor through the trajectory space by a plurality of convex polytopes defined by the plurality of control points.

19. The method of claim 17, wherein the optimal control problem comprises at least one dynamic constraint for the vehicle trajectory, wherein the step of rewriting the optimal control problem in terms of the flat outputs of the optimal control problem to obtain the modified control problem comprises the step of:
rewriting the optimal control problem in terms of the flat outputs of the optimal control problem to remove the at least one dynamic constraint for the vehicle trajectory.

20. The method of claim 17, wherein the step of defining the feasible corridor with respect to the at least one trajectory constraint through employment of the plurality of control points of the NURBS basis functions comprises the step of:
determining at least one available corridor through the trajectory space through employment of a global solver, wherein the at least one available corridor comprises the feasible corridor;
selecting the feasible corridor from the at least one available corridor.
